(19) United States
(12) Patent Application Publication
(10) Pub. No.: US 2024/0205135 A1
(43) Pub. Date: Jun. 20, 2024

(54) MANAGING CONNECTION TIMERS FOR BORDER GATEWAY PROTOCOL IN A COMPUTING ENVIRONMENT

(71) Applicant: VMware LLC, Palo Alto, CA (US)

(72) Inventor: Ankur Dubey, San Jose, CA (US)

(21) Appl. No.: 18/066,021

(22) Filed: Dec. 14, 2022

(51) Int. Cl. H04L 45/02

(52) U.S. Cl. CPC H04L 45/04

(57) ABSTRACT

Described herein are systems, methods, and software to manage timers in association with border gateway protocol (BGP) connections in a computing environment. In at least one example, a management service identifies a deployment configuration of gateways in a computing environment and identifies one or more BGP connections for timer updates in the computing environment based on the deployment configuration. Once the one or more BGP connections are identified, the management service configures one or more of the gateways to reduce one or more timers associated with reconnecting the one or more BGP connections in response to a failure.

### TECHNICAL BACKGROUND

In computing networks, gateways use border gateway protocol (BGP) to manage the routing of packets between the gateways. BGP is used to advertise and route traffic between different routers, wherein a BGP session permits a first router to advertise prefixes available via the first router to a second router. From the advertised addresses, the second router can maintain a routing table that compares attributes in received packets and forwards the packets to the first router when they contain the corresponding addressing information.

While BGP permits routers to exchange routing and reachability information for packets in a network, BGP sessions or connections can fail between gateways. The failure can occur because of a physical network connection failure, a power failure, a software failure or update, or some other failure associated the BGP connection. As a result of the failure, the addressing information that was advertised by the failed gateway can be removed, preventing future packets from being directed via the failed connection. For example, in response to the failure of a first gateway, a second gateway can remove routing information that directs packets to the first gateway. Further, one or more timers are initiated to prevent the first gateway and second gateway from prematurely attempting to reestablish the BGP connection and unnecessarily using resources. However, while the timers can be used to prevent oscillation or attempting to reestablish the connection prematurely, the timers can cause unnecessary delays in reestablishing the BGP connection between two gateways.

### SUMMARY

The technology described herein manages the connection timers associated with border gateway protocol (BGP) connections between gateways of computing environment. In one implementation, a method of operating a management service for a computing environment includes identifying a deployment configuration of gateways in a computing environment. The method further includes identifying one or more BGP connections for timer updates in the computing environment based on the deployment configuration and configuring one or more of the gateways to reduce one or more timers associated with reconnecting the one or more BGP connections in response to a failure. The timers can comprise an IdleHoldTimer, a ConnectRetryTimer, or a DelayOpenTimer, or some other timer associated with reestablishing a BGP connection.

### BRIEF DESCRIPTION OF THE DRAWINGS

FIG. 1 illustrates a computing environment that manages timers associated with border gateway protocol (BGP) according to an implementation.

FIG. 2 illustrates a method of operating a management service for a computing environment to update timers associated with BGP connections according to an implementation.

FIG. 3 illustrates a timing diagram for updating timers associated with BGP connections according to an implementation.

FIG. 4 illustrates a timing diagram for initiating a hold timer for reestablishing a BGP connection according to an implementation.

FIG. 5 illustrates a management computing system that manages timers for BGP connections in a computing environment according to an implementation.

### DETAILED DESCRIPTION

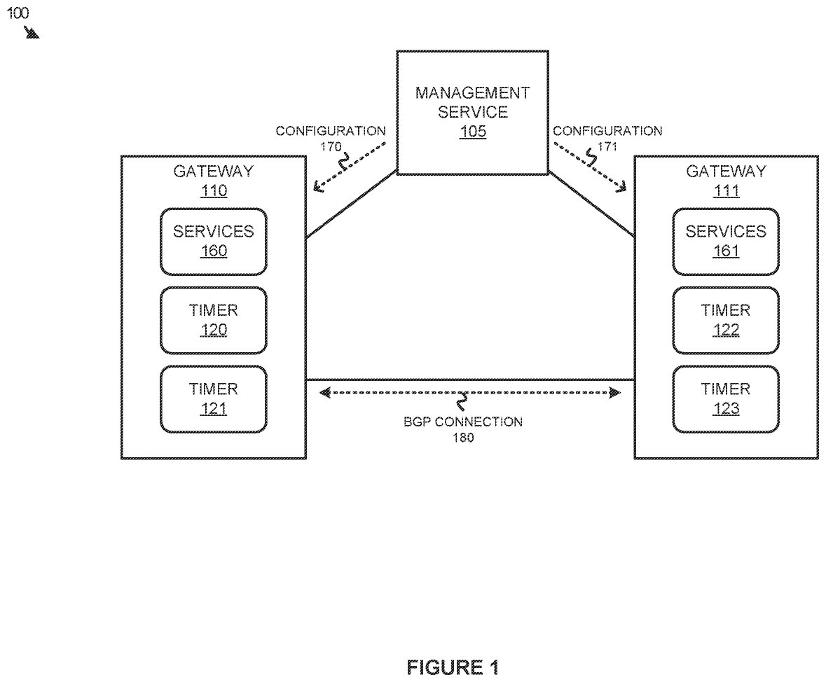

FIG. 1 illustrates a computing environment 100 that manages timers associated with border gateway protocol (BGP) according to an implementation. Computing environment 100 includes management service 105 and gateways 110-111. Gateways 110-111 further includes services 160-161 and timers 120-123. Gateways 110-111 usage BGP connection 180 to provide routing configuration information. Management service 105 provides configurations 170-171 to each gateway 110-111, wherein configurations 170-171 can be used to update timers 120-123 at each of gateways 110-112. Management service 105 can be implemented as part of one or more computers, wherein the computers can comprise servers, desktop computers, or some other computer. Although demonstrated in computing environment 100 with two gateways, any number gateways can be deployed as part of a computing environment managed by management service 105.

In computing environment 100, gateways 110-111 are representative of network devices capable of providing various services 160-161 for computing devices (physical and/or virtual) in the computing environment. The services can include routing services, firewall services, switching services, or some other network service. Gateways 110-111 can represent routers, servers, or some other computing device capable of providing the operations. The devices can include physical computers, virtual machines, containers, or some other virtualized endpoint.

To support the routing in computing environment 100, gateways 110-111 can use BGP connection 180 to exchange routing information. BGP provides management information about how packets are routed in a network, including routing and reachability information, such as prefix availability announcements. For example, gateway 110 can provide prefix availability information to gateway 111, providing gateway 111 with information about the prefixes that are available via gateway 110. However, during the BGP session between gateways 110-111, a failure can occur, wherein the failure can comprise a hardware failure of a gateway, a software failure associated with a gateway, a physical connection failure between the gateways, or some other failure associated with the BGP session between the gateways. In response to identifying a failure, timers are used to manage when the BGP connection can be reestablished. For example, a timer can be used to reduce the number of update messages sent between BGP peer gateways. In at least one example, a timer is initiated that prevents a gateway from accepting communications from a failed BGP connection for a period. Once the period expires, the gateways can accept a connection request for the failed BGP connection and reestablish the BGP session. Referring to an example in computing environment 100, following a hardware failure associated with gateway 110, gateway 111 can initiate a timer of timers 122-123 and prevent incoming connection requests from gateway 110 until the expiration of the timer. Once the timer expires, gateway 111 can accept a connection request from gateway 110 and exchange BGP messages with gateway 110. The timers associated with reestablishing a BGP connection can include an IdleHoldTimer that specifies the length of time the BGP peer is held in the idle state, a ConnectRetryTimer that is used to trigger periodic connection establishment retry attempts while communication is down between gateways, a DelayOpenTimer that is used to delay the sending of an OPEN message for the connection, or some other timer associated with reconnecting a BGP connection.

Here, management service 105 is provided that provides configurations 170-171 that define the timer or timers associated with reestablishing BGP connections in a computing environment, wherein the timers can include timers associated with flap damping in some examples. In at least one implementation, management service 105 determines a deployment configuration associated with the gateways in the computing environment. The deployment configuration can indicate whether two gateways are active/active peers, active/standby piers, gateways at different tiers of a network (e.g., topology information), types of hardware for each of the gateways, whether the gateways use BGP over virtual private networking (BGP over VPN), or some other information for the gateways. From the information, management service 105 will identify one or more BGP connections in the environment that should be provided with a reduced timer and provide a configuration to the one or more gateways associated with the one or more BGP connections. In reducing the timer, the timer can be reduced from a first value (e.g., 90 seconds to 30 seconds) or can be removed entirely in some examples. In at least one example, the one or more BGP connections are selected based on the relationship between the gateways supporting the connections satisfying one or more criteria. For example, BGP connections between active/standby peer gateways that use BGP over VPN can be selected by management service 105. Once the one or more BGP connections are identified, management service 105 can send a configuration to gateways that support the BGP connections to reduce a timer associated with reestablishing the identified connections.

In at least one implementation, management service 105 can receive administrator input indicative of reduced timer preferences, wherein the reduced timer preferences can identify BGP connection types for a reduced timer. The reduced timer preferences can indicate gateway relationship types that should trigger a reduction in one or more timers associated with reestablishing BGP connections. The connection types can include active/active gateway peers, active/standby gateway peers, peers that use BGP over VPN, or some other relationship of gateways in a computing environment. Once the reduced timer preferences are received, management service 105 can identify BGP connections for timer updates based on the timer preferences and a deployment configuration for the environment. For example, the preferences can indicate that all active/active pairs in a computing environment use a reduced IdleHoldTimer. Accordingly, management service 105 will identify BGP connections between gateways with an active/active configuration and update the IdleHoldTimer to a reduced value for those identified connections. Advantageously, the preferences for the computing environment can be employed in newly deployed gateways with BGP connections that satisfy the reduced timer preferences.

Although demonstrated in the previous example as configuring the timers based the deployment configuration for a computing environment, an administrator of the network can manually define the BGP connections associated with a reduced timer. For example, an administrator can identify BGP connection 180 for a reduced timer. In response to an indication provided by the administrator, management service 105 will provide configurations 170-171 that configure gateways 110-111 to reduce at least one timer associated with reestablishing BGP connection 180. As an example, timers 120 and 122 can be updated at gateways 110-111 to implement a reduced timer associated with flap damping (e.g., IdleHoldTimer). When a failure is identified by gateway 111 in association with BGP connection 180, gateway 111 can initiate timer 122 that was reduced in association with configuration 171. Once timer 122 expires, gateway 111 can attempt to reconnect with gateway 110. However, prior to the expiration of the timer, gateway 111 will not attempt to reconnect with gateway 110.

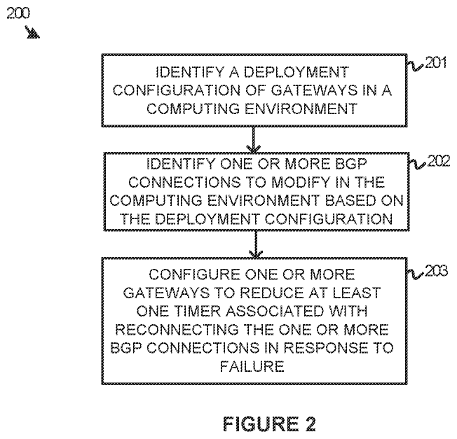

FIG. 2 illustrates a method 200 of operating a management service for a computing environment to update timers associated with BGP connections according to an implementation. The steps of method 200 are referenced parenthetically in the paragraphs that follow with reference to systems and elements of computing environment 100 of FIG. 1.

Method 200 includes identifying (201) a deployment configuration of gateways in a computing environment. The deployment configuration can include identifiers of gateways in the computing environment, relationships between the gateways in the computing environment (i.e., topology of the gateways in the computing environment), an indication of whether the BGP connections comprise BGP over VPN connections between gateways, or some other deployment information associated with gateways in the computing environment. Method 200 further includes identifying (202) one or more BGP connections for timer updates in the computing environment based on the deployment configuration. In some implementations, the BGP connections identified from the deployment configuration are compared to one or more criteria to reduce at least one timer associated with reconnecting a BGP connection after failure. The connections that satisfy the one or more criteria can be identified for a timer update. For example, management service 105 can identify BGP connections between gateways in an active/active configuration for timer updates. Once the one or more BGP connections are identified, method 200 configures (203) one or more of the gateways to reduce one or more timers associated with reconnecting the one or more BGP connections in response to a failure. The one or more timers can correspond to IdleHoldTimers at each of the gateways in the one or more BGP connectors, which stops reconnection attempts between gateways for a period. The timers can also include a ConnectRetryTimer, a DelayOpenTimer, or some other timer associated with reconnecting a BGP connection.

In at least one implementation, a gateway uses different timers for different BGP connections. For example, gateway 110 can use a first timer for BGP connection 180, while gateway 110 can use a second timer for BGP connections with one or more other gateways. The second timer can be a default timer length, while the first timer can be a length that is shortened via the configuration from management service 105. When BGP connection 180 fails, such as when gateway 111 experiences a power failure, gateway 110 can initiate a timer associated with BGP connection 180, preventing gateway 110 from reconnecting with gateway 111 prior to the expiration of the timer. The timer can drop incoming requests and prevent outgoing requests in some examples. Once the timer expires, gateway 110 can attempt to reconnect with gateway 111 to reestablish the BGP connection to exchange routing information with gateway 111.

In some examples, an administrator associated with a computing environment can provide reduced timer preferences that indicate BGP connection types for a reduced timer. The preferences can indicate relationships between gateways (i.e., active/active, active/standby, tier-1 to tier-2, etc.), can indicate whether the gateways use BGP over VPN, or can indicate some other preferences for the BGP connections to be associated with a reduced timer. Once the preferences are provided, management service 105 can identify BGP connections in the computing environment that satisfy the reduced timer preferences and configure the gateways associated with the identified BGP connections to reduce the timers associated with reconnecting.

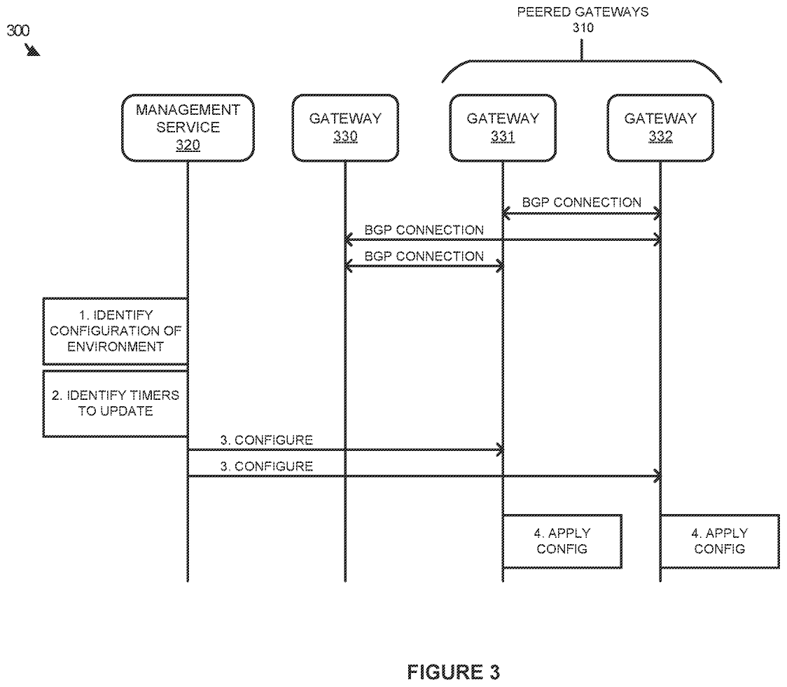

FIG. 3 illustrates a timing diagram 300 for updating timers associated with BGP connections according to an implementation. Timing diagram 300 includes management service 320 and gateways 330-332, wherein gateways 331-332 represent peer gateways 310 (e.g., active/active gateways in a computing environment).

In timing diagram 300, gateways 330-332 establish BGP connections to exchange routing and reachability information in a computing environment. The information can include prefix information, which directs packets based on prefixes to a corresponding gateway of gateways 330-332. While gateways 330-332 can exchange BGP information, management service 320 identifies a deployment configuration associated with gateways 330-332 at step 1. The deployment configuration can identify relationships associated with the different gateways in the computing environment, such as a topology of the gateways, indications of active/active or active/standby routers, an indication of whether the gateways use BGP over VPN, or some other deployment configuration information associated with the computing environment. From the deployment configuration, management service 320 identifies one or more timers associated reconnection to update at step 2.

In at least one example, management service 320 will identify BGP connections in the computing environment that satisfy criteria for reducing a timer associated reconnecting a failed BGP connection. The BGP connections can be identified based on the relationship between the two gateways that support the BGP connection. For example, management service 320 can identify gateways that are in peered in an active/active configuration or an in an active/standby configuration. Once the one or more BGP connections are identified, management service 320 configures the gateways associated with one or more BGP connections to reduce at least one timer associated with reconnecting the one or more BGP connections after failure. Here, management service 320 identifies that the BGP connection between gateways 331-332 satisfy criteria for a reduced timer. Accordingly, management service 320 configures, at step 3, gateways 331-332 to reduce the timer associated with the BGP connection and gateways 331-332 apply the configuration by using the reduced timer after detection of a failure associated with the BGP connection at step 4.

As demonstrated in the example of timing diagram 300, a gateway can deploy different timers depending on the BGP connection. As an example, the BGP connection between gateway 330-331 may not qualify for a reduced timer and gateway 331 can instead use a first timer for BGP failures. However, for the BGP connection between gateways 331-332, gateway 331 can use a second timer (the reduced timer) in response to detecting a failure in the connection with gateway 332.

Although demonstrated in the previous example as using at least a deployment configuration to determine how timers should be set in association with gateways of a computing environment, management service 320 can use user preferences in addition to or in place of the deployment configuration. In at least one example, an administrator of a computing environment can provide reduced timer preferences that indicate the types of BGP connections to reduce the one or more timers. The preferences can indicate that timers for BGP connections between active/active gateways be reduced, timers for BGP connections between active/standby gateways be reduced, or some other preference in association with the types of BGP connections. After the preferences are provided, management service 320 can identify a deployment configuration of the environment (e.g., topology information) to determine the BGP connections that qualify for the preferences. Once identified, a configuration can be provided to gateways in the environment to reduce at least one timer associated with reconnecting after failure that qualify for the preferences selected by the user. Advantageously, even when new BGP connections are initiated or configured in the environment, the preferences can be applied to any new BGP connections that satisfy the preferences of the administrator. In some implementations, rather than providing preferences that identify BGP connection types for a reduced timer, the administrator can manually indicate the BGP connections for a reduced timer associated with reconnecting a failed connection between gateways. In response to the indication by the administrator, management service 320 can distribute a configuration to the gateways associated with the connection to implement the reduced timers (e.g., timers associated with flap damping).

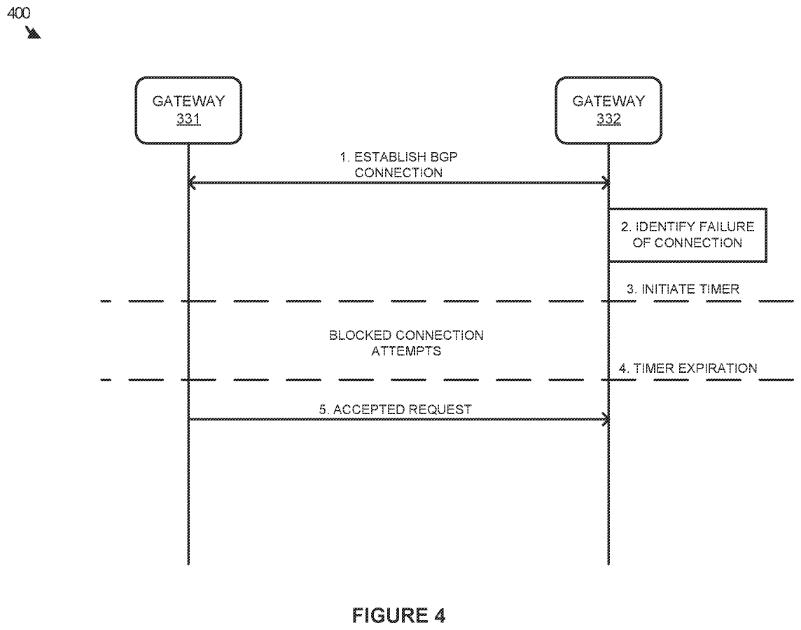

FIG. 4 illustrates a timing diagram 400 for initiating a hold timer for reestablishing a BGP connection according to an implementation. Timing diagram 400 includes gateways 331-332 of timing diagram 300. Timing diagram 400 is an example of implementing a reduced timer associated with flat damping based on a configuration provided by a management service.

In timing diagram 300, gateways 331-332 establish, at step 1, a BGP connection that is used to provide routing and reachability information between the gateways. This connection is associated with a reduced timer (e.g., IdleHoldTimer) defined by the management service to reduce the delay associated with reestablishing a BGP connection following a failure. After the configuration is applied at gateways 331-332, gateway 332 identifies a failure of the connection at step 2. In some examples, the failure can be identified using keep alive packets that are communicated periodically between gateways 331-332. When gateway 331 does not provide a keep alive packet in a required period, gateway 332 can determine that the connection has failed. The failure can be caused by hardware, software, or some other failure in association with gateway 331. Once the failure is detected, gateways 332 initiates a timer at step 2 to prevent the reconnection of the BGP session with gateway 331. The timer is configured by management service 320 (not pictured) to be reduced from a default value associated with the BGP connection.

After the timer is initiated, gateway 332 can prevent a connection from being established with gateway 331 until the expiration of the timer at step 4. Once the timer expires, gateway 332 can accept the request from gateway 331 to reestablish the BGP connection at step 5. Here, by reducing the timer (e.g., IdleHoldTimer), the BGP connection can be established quicker than was otherwise possible with the default timer associated with the BGP connection.

Further, while demonstrated in the example of timing diagram 400 as using a reduced timer for the BGP connection of gateways 331-332, gateways can maintain different timers for different BGP connections. Specifically, for connections that do not satisfy criteria in the deployment configuration, the gateways can use a second timer that is longer than the timer used between gateways 331.

In some implementations, a computing environment can use a variety of different timer lengths based on the type of BGP connection between the gateways. For example, a first set of BGP connections can be associated with a first timer length for reconnection, a second set of BGP connections can be associated with a second timer length for reconnection, and a third set of BGP connections can be associated with a third timer length for reconnection. Management service 320 can identify the different BGP connection types between the gateways based on the deployment configuration and determine a timer length for each of the BGP connections based on the BGP connection type. For example, gateways that operate as active/active peers can be assigned a first timer length for the corresponding BGP connection, while gateways that operate in different tiers (e.g., tier-1 and tier-2 routers) can be assigned a second timer length. In some examples, management service 320 will use a default length for the flat damping timers and only modify or reduce the timers when the connections (e.g., gateway relationships) satisfy one or more criteria.

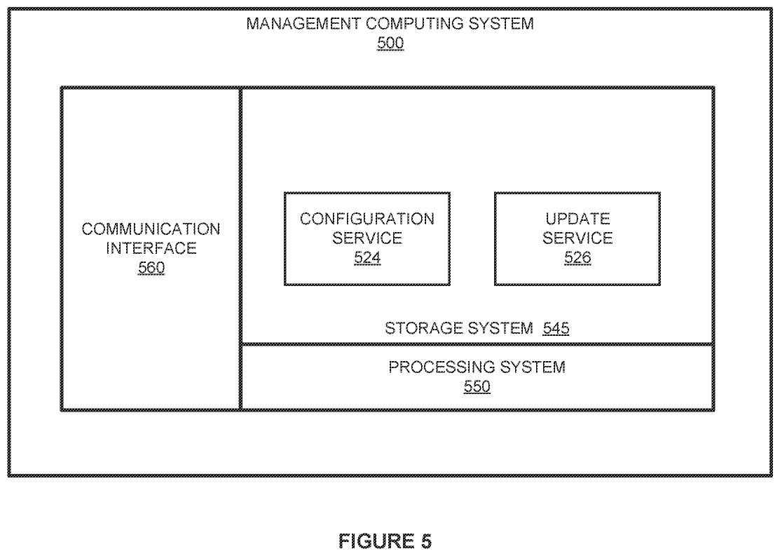

FIG. 5 illustrates a management computing system 500 that manages timers for BGP connections in a computing environment according to an implementation. Computing system 500 is representative of any computing system or systems with which the various operational architectures, processes, scenarios, and sequences disclosed herein for a management service can be implemented. Computing system 500 is an example of management services 105 and 320 from FIGS. 1 and 3, respectively, although other examples may exist. Computing system 500 includes storage system 545, processing system 550, and communication interface 560. Processing system 550 is operatively linked to communication interface 560 and storage system 545. Communication interface 560 may be communicatively linked to storage system 545 in some implementations. Computing system 500 may further include other components such as a battery and enclosure that are not shown for clarity.

Communication interface 560 comprises components that communicate over communication links, such as network cards, ports, radio frequency (RF), processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format—including combinations thereof. Communication interface 560 can communicate with gateways, computing systems, and other computing elements in a computing environment to manage networking configurations in a computing environment.

Processing system 550 comprises microprocessor and other circuitry that retrieves and executes operating software from storage system 545. Storage system 545 may include volatile and nonvolatile, removable, and non-removable media implemented in any method or technology for storage of information, such as computer readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises configuration service 524 and update service 526. The operating software on storage system 545 may further include an operating system, utilities, drivers, network interfaces, applications, or some other type of software. When read and executed by processing system 550 the operating software on storage system 545 directs computing system 500 to operate as described herein. In at least one example, the operating software can provide at least method 200 described above in FIG. 2.

In at least one implementation, configuration service 524 directs processing system 550 to identify a deployment configuration of gateways in a computing environment. The deployment configuration can indicate gateways in the computing environment, relationships between gateways in the computing environment (e.g., topology), the type of connection (e.g., standard BGP or BGP over VPN), or some other information for the gateways. For example, the deployment configuration can indicate tiers within the computing environment, active/active peers in the computing environment, active/standby peers in the computing environment, or some other relationship between gateways in an environment. In some implementations, the deployment configuration can indicate locations associated with the gateways, such as local locations, cloud locations, and the like. Configuration service 524 further directs processing system 550 to identify one or more BGP connections for timer updates in the computing environment based on the deployment configuration. In some examples, different gateway relationships can use different timer lengths in association with flap damping or reconnecting following a failure. For example, active/active peered gateways in a computing environment can be permitted to use a smaller IdleHoldTimer than gateways with a BGP connection that are in a different relationship.

Once the one or more BGP connections are identified in the computing environment, update module 526 directs processing system 550 to configure one or more of the gateways to reduce one or more timers associated with flap damping for the one or more BGP connections. As an example, a BGP connection between a first gateway and a second gateway can be identified by management computing system 500 for modification. Management computing system 500 can communicate a configuration to each of the gateways to set a timer for the BGP connection to a reduced value. After configuration, each of the first gateway and the second gateway can monitor to determine whether a connection with the other gateway is interrupted. For example, the first gateway can determine that the second gateway is no longer reachable when keep alive packets are not received from the second gateway for a period. In response to determining that the second gateway is unavailable, the first gateway can remove routes that were directed to the second gateway and can initiate the reduced timer associated with the BGP connection to the second gateway. The timer will prevent the BGP connection from being reestablished prior to the expiration of the timer. Once the timer is expired, the BGP connection between the first gateway and the second gateway can be reestablished via a request from the second gateway to permit routing and reachability information to be exchanged between the gateways.

In some implementations, a gateway can use BGP to communicate with multiple different routers. For example, a gateway can communicate with a gateway in another tier (e.g., tier 2 gateway communicating with a tier 1 gateway) and can further communicate with a standby peer for failover operations. For each of the different BGP connections, the gateway can maintain a corresponding timer, wherein a shorter timer can be used for BGP connections that satisfy one or more criteria, and a longer timer can be used for BGP connections that done satisfy the one or more criteria.

In at least one example, an administrator of the computing environment can provide reduced timer preferences, wherein the reduced timer preferences identify BGP connection types for a reduced timer. The connection types can be defined by one or more criteria, such as the relationship between the gateways associated with the BGP connection, the location of the gateways relative to each other, or some other criteria to trigger a reduced timer associated with reconnecting BGP connections in response to failure. For example, an administrator can indicate that any BGP connection between gateways with an active/active relationship should be assigned a reduced timer relative to other BGP connections. Once the preferences are identified from an administrator, configuration service 524 directs processing system 550 to identify BGP connections in a computing environment that match the preferences from the administrator (match the criteria specified from the administrator). The matches can be determined at least in part from the deployment configuration of the environment that can demonstrate a topology or relationship between the different gateways in the computing environment.

Although demonstrated in the previous examples as configuring the gateways of a computing environment using a deployment configuration and preferences of an administrator of a computing environment, the administrator can explicitly indicate individual BGP connections that should use a reduced timer. In selecting the BGP connections, a notification can be sent to the gateways associated with BGP connections to reduce at least one timer associated with reconnecting a failed connection. Any other connections that are not identified by the administrator for at least one reduced timer can remain at a default setting associated with BGP.

In some implementations, depending on the relationship of the gateways in the computing environment, configuration service 524 can select different reduced timers. For example, a first relationship between a first set of gateways can permit management computing system 500 to configure the first set of gateways to use a first reduced timer in association with the corresponding BGP connections. Additionally, a second relationship between a second set of gateways can permit management computing system 500 to configure the second set of gateways to use a second reduced timer in association with the corresponding BGP connections. In some examples, a gateway can employ one or more different timers in association with the different BGP connections.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
identifying a deployment configuration of gateways in a computing environment;
identifying one or more border gateway protocol (BGP) connections for timer updates in the computing environment based on the deployment configuration; and
configuring one or more of the gateways to reduce one or more timers associated with reconnecting the one or more BGP connections in response to a failure.

2. The method of claim 1, wherein identifying the deployment configuration comprises identifying a topology of the of the gateways in the computing environment.

3. The method of claim 1, wherein the one or more timers associated with reconnecting the one or more BGP connections comprise an IdleHoldTimer, a ConnectRetryTimer, or a DelayOpenTimer.

4. The method of claim 1, wherein identifying the one or more BGP connections for timer updates comprises identifying one or more BGP connections between active/active gateways or active/standby gateways.

5. The method of claim 1, wherein identifying the one or more BGP connections for timer updates comprises identifying one or more BGP connections between gateways that use BGP over virtual private network (VPN).

6. The method of claim 1 further comprising:
in a first gateway of the one or more gateways, identifying a failure associated with a BGP connection of the one or more BGP connections; and
in the first gateway and in response to the failure, initiating a timer of the one or more timers.

7. The method of claim 6, wherein identifying the failure associated with the BGP connection comprises failing to receive a keep alive packet.

8. The method of claim 1 further comprising:
identifying reduced timer preferences, wherein the reduced timer preferences identify BGP connection types for a reduced timer; and
wherein identifying one or more border gateway protocol (BGP) connections for timer updates in the computing environment based on the deployment configuration is further based on the reduced timer preferences.

9. A computing apparatus comprising:
a storage system;
a processing system operatively coupled to the storage system; and
program instructions on the storage system that, when executed by the processing system, direct the computing apparatus to:
identify a deployment configuration of gateways in a computing environment;
identify one or more border gateway protocol (BGP) connections for timer updates in the computing environment based on the deployment configuration; and
configure one or more of the gateways to reduce one or more timers associated with reconnecting the one or more BGP connections in response to a failure.

10. The computing apparatus of claim 9, wherein identifying the deployment configuration comprises identifying a topology of the of the gateways in the computing environment.

11. The computing apparatus of claim 9, wherein the one or more timers associated with reconnecting the one or more BGP connections comprise an IdleHoldTimer, a ConnectRetryTimer, or a DelayOpenTimer.

12. The computing apparatus of claim 9, wherein identifying the one or more BGP connections for timer updates comprises identifying one or more BGP connections between active/active gateways or active/standby gateways.

13. The computing apparatus of claim 9, wherein identifying the one or more BGP connections for timer updates comprises identifying one or more BGP connections between gateways that use BGP over virtual private network (VPN).

14. The computing apparatus of claim 9, wherein the program instructions further direct the computing apparatus to:
identify reduced timer preferences, wherein the reduced timer preferences identify BGP connection types for a reduced timer; and
wherein identifying one or more border gateway protocol (BGP) connections for timer updates in the computing environment based on the deployment configuration is further based on the reduced timer preferences.

15. A system comprising:
gateways; and
a management service computing system configured to:
identify a deployment configuration of gateways in a computing environment;
identify one or more border gateway protocol (BGP) connections for timer updates in the computing environment based on the deployment configuration; and
configure one or more of the gateways to reduce one or more timers associated with reconnecting the one or more BGP connections in response to a failure.

16. The system of claim 15, wherein identifying the deployment configuration comprises identifying a topology of the of the gateways in the computing environment.

17. The system of claim 15, wherein the one or more timers associated with reconnecting the one or more BGP connections comprise an IdleHoldTimer, a ConnectRetryTimer, or a DelayOpenTimer.

18. The system of claim 15, wherein identifying the one or more BGP connections for timer updates comprises identifying one or more BGP connections between active/active gateways or active/standby gateways.

19. The system of claim 15, wherein a first gateway of the one or more gateways is configured to:
identify a failure associated with a BGP connection of the one or more BGP connections; and
initiate a timer of the one or more timers.

20. The system of claim 15, wherein the management service is further configured to:
identify reduced timer preferences, wherein the reduced timer preferences identify BGP connection types for a reduced timer; and
wherein identifying one or more border gateway protocol (BGP) connections for timer updates in the computing environment based on the deployment configuration is further based on the reduced timer preferences.
